(19) United States
(12) Patent Application Publication
(10) Pub. No.: US 2018/0203212 A1
(43) Pub. Date: Jul. 19, 2018

(54) TERAHERTZ-GIGAHERTZ FISHEYE LENS SYSTEM

(71) Applicant: Archit Lens Technology Inc., Hsinchu City (TW)

(72) Inventors: Lawrence Dah-Ching Tzuang, Zhubei City (TW); Yen-Ju Wu, Sheffield (GB)

(21) Appl. No.: 15/409,743

(22) Filed: Jan. 19, 2017

(51) Int. Cl. G02B 13/14; G02B 13/06; G02B 1/02; G01J 3/28; G01J 3/02

(52) U.S. Cl. CPC G02B 13/14; G02B 13/06; G01J 3/0208; G01J 3/2823; G02B 1/02

(57) ABSTRACT

Terahertz-gigahertz fisheye lens systems that may be implemented in or attached to many gigahertz/terahertz systems (such as imaging or security system) are proposed. Each proposed terahertz-gigahertz fisheye lens system includes three lens elements in which combined provides a FOV of about 160°. Each lens element is made of quartz or materials having similar refractive indices. The surfaces of each lens element are either planar and/or spherical. Furthermore, the radius of curvature, diameter, surface profile, size, spacing, and material of the lens elements may be selected to achieve quality performance. Also, to change the focusing distance for achieving optimum imaging resolution, the spacing between these lens element and the image sensor (or the object) may be adjusted.

### FIELD OF THE INVENTION

The present invention relates to the quasi-optical fisheye lens system, especially to the fisheye lens system designed particularly for the terahertz-gigahertz (THz) ray.

### BACKGROUND OF THE INVENTION

The fisheye lens system generally has a lens or a set of lens elements where the Field of View (FOV) is about 160° to 180° or more and the incidence angle of an incident ray is nonlinearly dependent on the image height on the image plane. In optics, the fisheye lens system has been applied in many applications, for example but not limited to the following: special camera lenses, scientific study, all-sky observation photography, entertainment, and security surveillance. The imaging system may use the fisheye lens system to provide a very wide or hemispherical image, to project semi-spherical surface on a plane and so on.

The interest in THz technology significantly increased during the past years. However, the currently available fisheye lens system is designed for optical systems, which cannot be applied directly to THz applications. One of the reasons why the current optical fisheye lens system designs cannot be used in THz system is that the lens material properties are very different. The second reason is that the physical size of the fisheye lens system needs to be much larger for THz applications to avoid diffraction-limited resolution. Therefore, simply scaling conventional optical fisheye lens system designs with five, six, or more lens elements for THz applications will inevitably become too heavy, expensive, and difficult to manufacture.

Therefore, it is required to provide specific design(s) of the terahertz-gigahertz fisheye lens system operating in the frequency range about a few tens to few hundreds of GHz.

### SUMMARY OF THE INVENTION

The present invention proposes the fisheye lens system for the THZ ray. Especially, the lens elements in the present invention are made of quartz or other similar material(s) (in terms of the refractive index), and the fisheye lens system design is applicable in the frequency range of about 20 to 200 GHz.

Some embodiments are several versions of the fisheye lens system that the lens elements are made of quartz and/or other material(s) having similar refractive indices. These embodiments use only three lens element with different shapes, sizes and spacing between adjacent lens elements. On each of the two particularly illustrated embodiments, one lens element has a spherical surface and a planar surface, another lens element has two different spherical surfaces, and the other lens element has another two different spherical surfaces. Furthermore, for all of illustrated and non-illustrated embodiments, the refractive index of material used to form the lens elements, the distance between neighboring lens elements, the thickness of each lens element, the diameter of each lens element, and the radius of each surface of each lens element may be altered slightly. For example, a ten percent of design tolerance on a few parameters is acceptable, and the fisheye lens system parameters alter slightly accordingly. In other words, the EFL (Effective Focal Length) and the F# (f-number) of all present examples of this invention may be altered according to the lens system parameters and not limited strictly.

### BRIEF DESCRIPTION OF THE DRAWINGS

FIG. 1 is a cross-sectional illustration of an embodiment of a terahertz-gigahertz fisheyes lens system that includes three lens elements made of quartz.

FIG. 2 is a cross-sectional illustration of an embodiment of a terahertz-gigahertz fisheye lens system that includes three lens elements made of quartz.

### DETAILED DESCRIPTION OF THE INVENTION

Reference will now be made in details to specific embodiment of the present invention. Examples of these embodiments are illustrated in the accompanying drawings. While the invention will be described in conjunction with these specific embodiments, it will be understood that the intent is not to limit the invention to these embodiments. In fact, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without at least one of these specific details. In other instances, the well-known portions are less or not described in detail in order not to obscure the present invention.

Some embodiments of fisheye lens system designed for terahertz-gigahertz rays are proposed. These proposed terahertz-gigahertz fisheye lens system are some kind of quasi-optical fisheye lens system and may be implemented in or attached to the terahertz-gigahertz camera, the terahertz-gigahertz imaging system, the terahertz-gigahertz sensing system, or many other terahertz-gigahertz systems/applications.

Two of the present embodiments of the terahertz-gigahertz fisheye lens system are particularly illustrated. Each illustrated embodiment has three lens elements made of quartz, where the three lens elements are concave-plano lens element, concave-convex lens element and convex-convex lens element respectively. Further, each non-planer surface of the three lens elements is a spherical surface, although all non-planar surfaces of these lens elements are different.

In addition, the illustration of the present embodiments are based on the assumption that each of these illustrated fisheye lens systems is rotational symmetrical along the optical axis extending from the left hand side to the right hand side of the drawing. Also, the image plane and the object where the THZ rays come from are positioned on two opposite sides of these lens elements along the optical axis respectively.

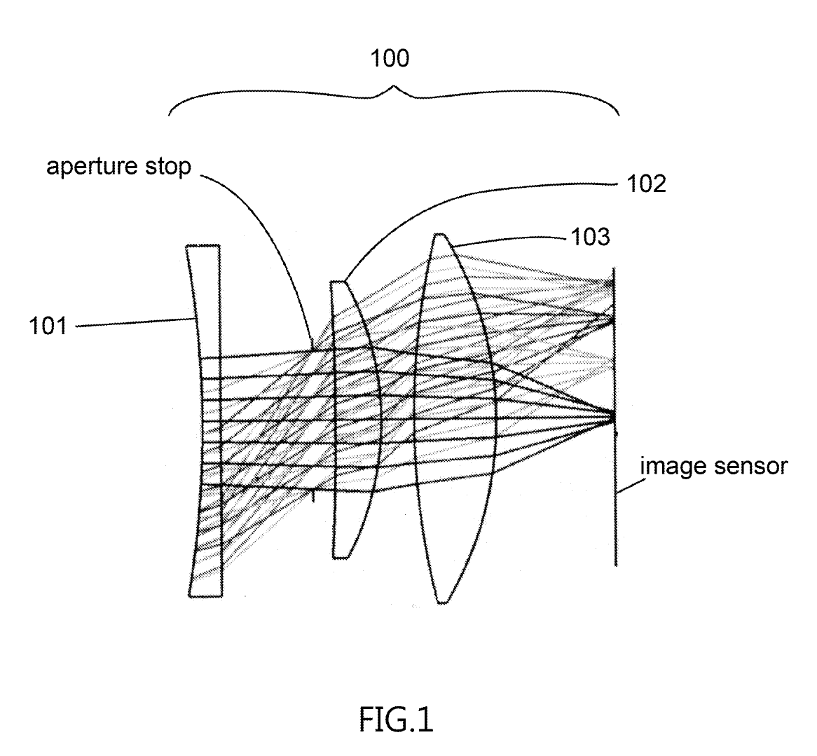

FIG. 1 illustrates the cross-sectional structure of an example embodiment (THz fisheye lens system 100), which consists of three lens elements 101, 102 and 103 positioned along the optical axis in sequence and are all made of quartz with refractive index 1.95, covers the applications for terahertz-gigahertz rays within the frequency range of 20 to 200 GHz. To simplify the drawings, only the terahertz-gigahertz rays arrived at the upper half of the image formed on the image plane (where an image sensor is positioned) is illustrated. The first lens element 101 is a plano-concave lens element having a spherical left surface and a planar right surface, the second lens element 102 is a concave-convex lens element having two different spherical surfaces, and the third lens element 103 is a convex-convex lens element having another two different spherical surfaces. Therefore, the terahertz-gigahertz rays propagated from the most left side of these lens elements 101˜103 may be properly focused on the image plane behind the most right side of these lens elements 101˜103.

The system data and the lens prescription data for THz fisheye lens system 100 are shown in Table 1A and Table 1B, respectively.

TABLE 1A

| Effective Focal Length | 176 | mm |
|---|---|---|
| Half Field-Of-View | 80° | |
| f-number | 1.25 | |
| Total Track Length | 452 | mm |
| Design Frequency | 20~200 | GHz |

TABLE 1B

| | | | | Refrac- | |
|---|---|---|---|---|---|
| Element Name/ | | | Thickness/ | tive | Di- |
| Surface Number | Radius | Type | Distance | Index | ameter |
| Lens Element 101 | −1097 mm | Spherical | 20 mm | 1.95 | 380 mm |
| (Left Surface) 1 | | | | | |
| Lens Element 101 | INF | Flat | 101 mm | 1.0 | 380 mm |
| (Right Surface) 2 | | | | | |
| 3 Aperture Stop | INF | Flat | 25 mm | N/A | 150 mm |
| Lens Element 102 | −2657 mm | Spherical | 50 mm | 1.95 | 300 mm |
| (Left Surface) 4 | | | | | |
| Lens Element 102 | −315 mm | Spherical | 36 mm | 1.0 | 300 mm |
| (Right Surface) 5 | | | | | |
| Lens Element 103 | 826 mm | Spherical | 90 mm | 1.95 | 400 mm |
| (Left Surface) 6 | | | | | |
| Lens Element 103 | −387 mm | Spherical | 130 mm | 1.0 | 400 mm |
| (Right Surface) 7 | | | | | |
| 8 Image Sensor | INF | Flat | N/A | N/A | 320 mm |

For each lens element, the radius is positive if the center of curvature is on the right hand side of the lens element and is negative if the center of curvature is on the left hand side of the lens element. The diameter is defined as the size of the cross-section perpendicular to the optical axis. The thickness/distance is defined as the distance between two adjacent neighboring surfaces along the optical axis. The total track length TTL of a fisheye lens system is defined as the distance from the image plane to a surface of the lens elements most far away from the image plane along the optical axis. The EFL is defined as the distance between the rear principal plane of the lens system to the rear focal point positioned behind the last lens element (i.e., behind the rightmost surface of these lens elements) calculated at infinite conjugate. The HFOV is defined as: HFOV=tan⁻¹ (SS/2f), whereas SS is the diameter (width or height) of the image sensor positioned on the image surface, whereas the f-number (f) is defined as: f-number=EFL/D, where D is the diameter of the aperture stop. Herein, the aperture stop is positioned between the first lens element 101 and the second lens element 102. The distance between the right surface of the first lens element 101 and the aperture stop is 101 mm, and the diameter of the aperture stop is 150 mm. Herein, the image sensor is positioned on the right side of the right surface of the lens element 103, and the distance between the third lens element 103 and image sensor is 130 mm. In addition, the diameter of the image sensor is 320 mm.

As shown in Table 1B, for lens element 101, the radius of the left surface (1097 mm) is shorter than the radius of the right surface (infinite), but for both lens elements 102/103, the radius of the left surface (2657 mm/826 mm) of each of lens elements 102/103 is longer than the radius of the right surface (315 mm/387 mm). The thickness (50 mm) of lens element 102 is larger than the thickness (20 mm) of lens element 101 but is smaller than the thickness (90 mm) of lens element 103. Further, for example, the thickness/distance for surface 1 defines the thickness of lens element 101 along the optical axis, but the thickness/distance for surface 5 defines the distance between the right surface of lens element 102 to the left surface of the lens element 103 along the optical axis.

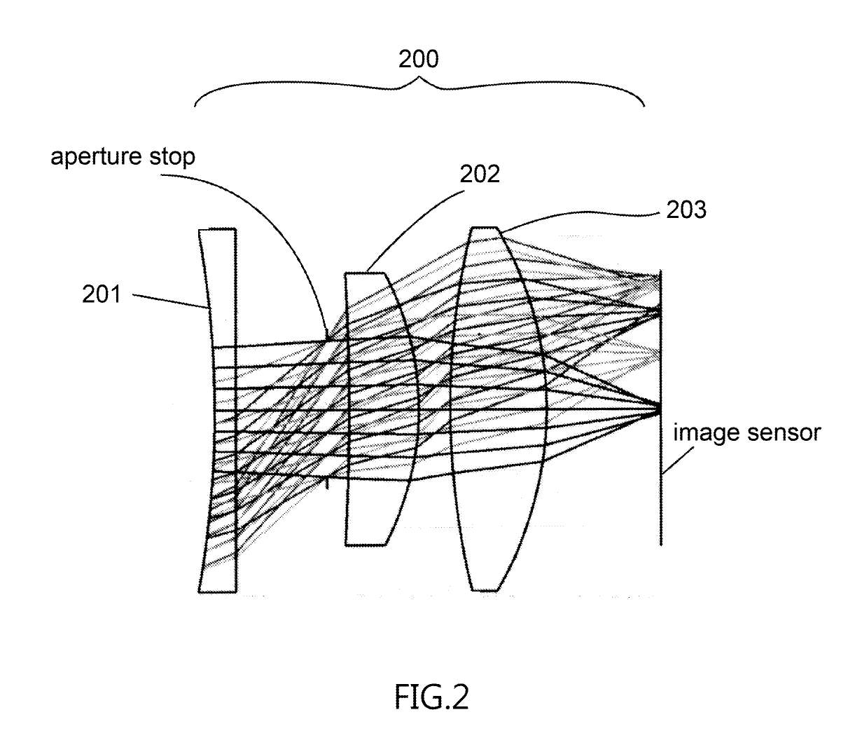

FIG. 2 illustrates the cross-sectional structure of an example embodiment (THz fisheye lens system 200), which consists of three lens elements 201, 202 and 203 positioned along the optical axis in sequence and are all made of quartz with refractive index 1.95, covers the applications for terahertz-gigahertz rays within frequency range of 20 to 200 GHz. To simplify the drawings, only the terahertz-gigahertz rays arrived at the upper half of the image formed on the image plane is illustrated. The lens element 201 is a concave-plano lens element having a spherical left surface and a planar right surface, the lens element 202 is a concave-convex lens element having two different spherical surfaces, and the lens element 203 is a convex-convex lens element having another two different spherical surfaces. Therefore, the terahertz-gigahertz rays propagated from the most left side of these lens elements 201˜203 may be properly focused on the image plane behind the most right side of these lens elements 201˜203.

The system data and the lens prescription data for THz fisheye lens system 200 are shown in Table 2A and Table 2B, respectively.

TABLE 2A

| Effective Focal Length | 70 | mm |
|---|---|---|
| Half Field-Of-View | 80° | |
| f-number | 1.24 | |
| Total Track Length | 199 | mm |
| Design Frequency | 20~200 | GHz |

TABLE 2B

| Element Name/ | | | | Refrac- | |
|---|---|---|---|---|---|
| Surface | | | Thickness/ | tive | Di- |
| Number | Radius | Type | Distance | Index | ameter |
| Lens Element | −439 mm | Spherical | 9.5 mm | 1.95 | 160 mm |
| 101 (Left | | | | | |
| Surface) 1 | | | | | |
| Lens Element | INF | Flat | 40.5 mm | 1.0 | 160 mm |
| 101 (Right | | | | | |
| Surface) 2 | | | | | |
| 3 Aperture | INF | Flat | 10 mm | N/A | 60 mm |
| Stop | | | | | |
| Lens Element | −1062 mm | Spherical | 31 mm | 1.95 | 120 mm |
| 102 (Left | | | | | |
| Surface) 4 | | | | | |
| Lens Element | −126 mm | Spherical | 14 mm | 1.0 | 120 mm |
| 102 (Right | | | | | |
| Surface) 5 | | | | | |
| Lens Element | 331 mm | Spherical | 43 mm | 1.95 | 160 mm |
| 103 (Left | | | | | |
| Surface) 6 | | | | | |
| Lens Element | −155 mm | Spherical | 51 mm | 1.0 | 160 mm |
| 103 (Right | | | | | |
| Surface) 7 | | | | | |
| 8 Image Sensor | INF | Flat | N/A | N/A | 120 mm |

For each lens element, the radius is positive if the center of curvature is on the right hand side of the lens element and is negative if the center of curvature is on the left hand side of the lens element. The diameter is defined as the size of the cross-section perpendicular to the optical axis. The thickness/distance is defined as the distance between two adjacent neighboring surfaces along the optical axis. The total track length TTL of a fisheye lens system is defined as the distance from the image plane to a surface of the lens elements most far away from the image plane along the optical axis. The EFL is defined as the distance from the rear principal plane of the lens system to the rear focal point positioned behind the last lens element (i.e., behind the rightmost surface of these lens elements) calculated at infinite conjugate. The HFOV is defined as: HFOV=tan⁻¹ (SS/2f), whereas SS is the diameter (width or height) of the image sensor positioned on the image surface to sensor the image, whereas the f-number (f) is defined as: f-number=EFL/D, where D is the diameter of the aperture stop located in front of these lens elements. Herein, the aperture stop is positioned between the first lens element 201 and the second lens element 202. The distance between the right surface of the first lens element 201 and the aperture stop is 40.5 mm, and the diameter of the aperture stop is 60 mm. Herein, the image sensor is positioned on the right hand side of the right surface of the lens element 203, and the distance between the third lens element 203 and image sensor is 51 mm. In addition, the diameter of the image sensor is 120 mm.

As shown in Table 2B, for lens element 201, the radius of the left surface (439 mm) is shorter than the radius of the right surface (infinite), but for both lens elements 202/203, the radius of the left surface (1062 mm/331 mm) is longer than the radius of the right surface (126 mm/155 mm). The thickness (31 mm) of lens element 202 is larger than the thickness (9.5 mm) of lens element 201 but is smaller than the thickness (43 mm) of lens element 203. Further, for example, the thickness/distance for surface 1 defines the thickness of lens element 201 along the optical axis, but the thickness/distance for surface 5 defines the distance between the right surface of lens element 202 and the left surface of the lens element 203 along the optical axis.

It should be emphasized that the parameters (including at least radius, thickness or distance, and refractive index) listed in Tables 1B and 2B may be altered slightly to achieve similar fisheye lens system performance, or to further reduce the lens aberrations, or to conform the housing design, or to account for the slight refractive index changes of the lens materials, or to achieve other benefit(s). Of course, the change of these dimensions automatically modifies the corresponding system data shown in Table 1A and Table 2A. Furthermore, even with the presence of these slight performance changes, the HFOV may be kept at about 80° by properly adjusting the size of the image sensor positioned on the image plane.

Table 3 presents the design tolerance and the range of the system data, which presents the acceptable variations of the example THz fisheye lens system 100 and 200. Note that these acceptable variations all have a HFOV about 80° (with image size compensated) and a designed frequency from 20 to 200 GHZ.

TABLE 3

| THz Fisheye | Refractive | | | | |
|---|---|---|---|---|---|
| lens system | Index | Thickness | Radius | EFL | F# |
| 100 | ±10% | ±10% | ±10% | 158~210 | 1.1~1.5 |
| 200 | ±10% | ±10% | ±10% | 60~85 | 1.1~1.5 |

Significantly, the geometrical configuration of the proposed THz fisheye lens system include some adjustable parameters, such as the thickness of the lens elements, the radius of each surface of the lens elements and the distance between neighboring lens elements. Also, the material of the lens elements also is an adjustable parameter, and is essentially limited by the refractive index. In other words, quartz is only an example material, but the lens elements may be made of any material whose refractive index is located in a range from 90% of quartz' refractive index to 110% of quartz's refractive index. Therefore, the acceptable variations may have a large range without drastically amending the example THz fisheye lens systems 100 and 200.

Significantly, by referring to Table 3, these example embodiments illustrated in FIG. 1 and FIG. 2 may be slightly altered to generate other acceptable THz fisheye lens systems. For example, by referring to Table 3, the variations of the THz fisheye lens system 100 illustrated in FIG. 1 may have lens element 101 with thickness about 18 to 22 mm (Table 1B presents 20 mm and Table 3 presents a range from subtracting 10% to adding 10%), lens element 102 with thickness about 45 mm to 55 mm (Table 1B presents 50 mm and Table 3 presents a range from subtracting 10% to adding 10%), and lens element 103 with thickness about 81 mm to 99 mm (Table 1B presents 90 mm and Table 3 presents a range from subtracting 10% to adding 10%). Also, lens element 101 and lens element 102 may be separated at a distance about 113.4 to 138.6 mm, and lens element 102 and lens element 103 may be separated at a distance about 32.4 to 39.6 mm (by referring to Table 1B, Table 2B and Table 3 similarly). Surely, the radius of each surface of the three lens elements 101/102/103 may also be amended by using the same way. For example, the variations of the THz fisheye lens system 100 illustrate in FIG. 1 may have lens element 101 whose left surface has radius about 987.3 mm to 1206.7 mm (Table 1B presents 1097 mm and Table 3 presents a range from subtracting 10% to adding 10%) and right surface has an infinite radius (Table 1B presents infinite and Table 3 presents a range from subtracting 10% to adding 10%), may have lens element 102 whose left surface has radius about 2391.3 mm to 2922.7 mm (Table 1B presents 2657 mm and Table 3 presents a range from subtracting 10% to adding 10%) and right surface has a radius about 283.5 mm to 346.5 mm (Table 1B presents 315 mm and Table 3 presents a range from subtracting 10% to adding 10%), and may have lens element 103 whose left surface has radius about 743.4 mm to 908.6 mm (Table 1B presents 826 mm and Table 3 presents a range from subtracting 10% to adding 10%) and right surface has a radius about 348.3 mm to 425.7 mm (Table 1B presents 387 mm and Table 3A presents a range from subtracting 10% to adding 10%). Furthermore, by referring to Table 3, the variations of the THz fisheye lens system 100 illustrated in FIG. 1 may have lens elements 101/102/103 made of material with refractive index from 1.755 to 2.145 (Table 1B presents refractive index 1.95 and Table 3 presents a range from subtracting 10% to adding 10%), which increases the acceptable materials for forming the lens elements 101/102/103. In addition, for each THz fisheye lens system, for all materials with acceptable refractive indices, the material(s) with less weight and less absorption of terahertz-gigahertz ray at the corresponding frequency range shown in Table 1A and Table 2A are preferred.

Accordingly, each of the illustrated embodiments has a different effective focal length (EFL) and a different f-number, also each variation of the present invention may have a different EFL and a different f-number.

In general, the proposed THZ fisheye lens systems 101/102 all have a HFOV range about 80°. In other words, for each of the THz fisheye lens systems 101/102, an object positioned on the left side of the first lens element 101/201 and inside the FOV range about 160° may be detected by an image sensor positioned on the right side of the third lens element 103/203. Hence, the variations of the THz fisheye lens system illustrated on FIG. 1 and Tables 1A/1B are designed such that an object positioned on the left hand side of the first lens element 101 at a finite distance is detected by an image sensor positioned on the right hand side of the third lens element 103 with a finite distance. Also, the variations of the fisheye lens system illustrated on FIG. 2 and Tables 2A/2B are designed such that an object positioned on the left hand side of the first lens element 201 at a finite distance is detected by an image sensor positioned on the right hand side of the third lens element 203 with a finite distance.

Moreover, although no particular example is illustrated, for all the embodiments and related variations discussed about, the size of the lens elements and the spacing between neighboring lens elements may be scaled with the size of the image sensor. That is to say, for each of the illustrated embodiments and their corresponding variations, the configurations of these lens elements may be scaled proportional to the size of the image sensor. Furthermore, not only the size of the aperture stop, but also the distance between the aperture stop and the first lens element (or other lens elements) may also be scaled with the size of the image sensor. For example, if the diameter of the image sensor is scaled up from 320 mm to 640 mm, the corresponding variations of the THz fisheye lens system 100 may have all three lens elements whose diameter, thickness, and radius of each surface doubled. For example, if the diameter of the image sensor is scaled down from 120 mm to 60 mm, the corresponding variations of the THz fisheye lens system 200 may have all three lens elements whose diameter, thickness and radius of each surface cut half.

As a short summary, by using any one of the examples (or relative variations) discussed above, a quasi-optical terahertz-gigahertz fisheye lens system suitable in the frequency range about 20 to 200 GHz may be achieved. The present invention has at least some advantages when compared to the conventional optical fisheye lens system designs. First, the sizes of the lens elements are large enough to have a higher image resolution only limited by diffraction. Second, the present invention uses only three lens elements, and the schematic of the present invention is simpler than the conventional fisheye lens system using typically five or more lens elements. Third, none of the surfaces of these lens elements are aspherical such that the lenses may be simply manufactured. Accordingly, the present invention may be implemented in or attached to the terahertz-gigahertz system, effectively. Note that the present invention is only related to the fisheye lens system itself. In other words, what the terahertz-gigahertz system is and how the proposed fisheye lens system is implemented in or attached to the terahertz-gigahertz system are not limited.

In additional, the aperture stop is ideally centered with respect to the optical axis. The aperture stop may be a separate part made of materials such as metals or absorbers, which reflects or absorbs the gigahertz-terahertz rays, as well as may be integrated in the lens housing. Ideally, the aperture stop is covered or integrated with terahertz-gigahertz absorptive materials. Reasonably, the smaller diameter of the aperture stop reduces lens aberration but enhances diffraction of the proposed fisheye lens system. The image sensor is also ideally centered with respect to the optical axis. Any commercial, well-known, on-developed or to-be-appeared sensor capable of receiving and detecting the terahertz-gigahertz ray may be used. For example, the image sensor may be achieved by using a 2D planar array of terahertz-gigahertz sensitive detectors.

Variations of the methods, the devices, the systems and the applications as described above may be realized by one skilled in the art. Although the methods, the devices, the systems, and the applications have been described relative to specific embodiments thereof, the invention is not so limited. Many variations in the embodiments described and/or illustrated may be made by those skilled in the art. Accordingly, it will be understood that the present invention is not to be limited to the embodiments disclosed herein, can include practices other than specifically described, and is to be interpreted as broadly as allowed under the law.

What is claimed is:

1. A terahertz-gigahertz fisheye lens system, comprising:
a first lens element, wherein the left surface of the first lens element is a spherical surface with a radius about 987.3 to 1206.7 mm and a diameter about 380 mm, wherein the right surface of the first lens element is a planar surface with an infinite radius and a diameter about 380 mm, wherein the thickness of the first lens element is about 18 to 22 mm;
a second lens element, wherein the left surface of the second lens element is a spherical surface with a radius about 2391.3 to 2922.7 mm and a diameter about 300 mm, wherein the right surface of the second lens element is a spherical surface with a radius about 283.5 to 346.5 mm and a diameter about 300 mm, wherein the thickness of the second lens element is about 45 to 55 mm; and
a third lens element, wherein the left surface of the third lens element is a spherical surface with a radius about 743.4 to 908.6 mm and a diameter about 400 mm, wherein the right surface of the third lens element is a spherical surface with a radius about 348.3 to 425.7 mm and a diameter about 400 mm, wherein the thickness of the third lens element is about 81 to 90 mm;
wherein the first lens element, the second lens element and the third lens element are positioned concentric along an optical axis;
wherein the first lens element is a concave-plano lens element, the second lens element is a concave-convex lens element and the third lens element is a convex-convex lens element;
wherein the first lens element, the second lens element and the third lens element are made of material(s) with refractive index about 1.755 to 2.145;
wherein the distance between the first lens element and the second lens element is about 113.4 to 138.6 mm and the distance between the second lens element and the third lens element is about 32.4 to 39.6 mm.

2. The terahertz-gigahertz fisheye lens system as claimed in claim 1, wherein the configuration of these lens elements is designed for the terahertz-gigahertz rays in the frequency range of 20 GHz to 200 GHz.

3. The terahertz-gigahertz fisheye lens system as claimed in claim 1, wherein at least one of the lens elements is made of quartz.

4. The terahertz-gigahertz fisheye lens system as claimed in claim 1, wherein an object positioned on the left side of the first lens element and inside the FOV range about 160° may be detected by an image sensor positioned on the right side of the third lens element.

5. The terahertz-gigahertz fisheye lens system as claimed in claim 1, wherein an image of an object positioned on the left hand side of the first lens element at a finite distance is detected by an image sensor positioned on the right hand side of the third lens element at a finite distance.

6. The terahertz-gigahertz fisheye lens system as claimed in claim 1, further comprising an image sensor positioned on the right side of the third lens elements, wherein the distance between the right surface of the third lens element and the image sensor is about 130 mm and the diameter of the image sensor is about 320 mm, wherein the image sensor and these lens elements are centered with respect to the optical axis.

7. The terahertz-gigahertz fisheye lens system as claimed in claim 6, wherein the size and spacing of these lens elements may be scaled with the size of the image sensor.

8. The terahertz-gigahertz fisheye lens system as claimed in claim 1, further comprises an aperture stop positioned between the first lens element and the second lens element, wherein the distance between the right surface of the first lens element and the aperture stop is about 101 mm and the diameter of the aperture stop is about 150 mm, wherein the aperture stop and these lens elements are centered with respect to the optical axis.

9. The terahertz-gigahertz fisheye lens system as claimed in claim 8, further comprising an image sensor positioned on the right side of the third lens elements, wherein the distance between the right surface of the third lens element and the image sensor is about 130 mm and the diameter of the image sensor is about 320 mm, wherein the image sensor and these lens elements are positioned concentric along the optical axis.

10. The terahertz-gigahertz fisheye lens system as claimed in claim 9, wherein both the size of the aperture stop and the distance between the aperture stop and the first and second lens elements may be scaled with the size of the image sensor.

11. A terahertz-gigahertz fisheye lens system, comprising:
a first lens element, wherein the left surface of the first lens element is a spherical surface with a radius about 395.1 to 482.9 mm and a diameter about 160 mm, wherein the right surface of the first lens element is a planar surface with an infinite radius and a diameter about 160 mm, wherein the thickness of the first lens element is about 8.55 to 10.45 mm;
a second lens element, wherein the left surface of the second lens element is a spherical surface with a radius about 955.8 to 1168.2 mm and a diameter about 120 mm, wherein the right surface of the second lens element is a spherical surface with a radius about 113.4 to 138.6 mm and a diameter about 120 mm, wherein the thickness of the second lens element is about 27.9 to 34.1 mm; and
a third lens element, wherein the left surface of the third lens element is a spherical surface with a radius about 297.9 to 364.1 mm and a diameter about 160 mm, wherein the right surface of the third lens element is a spherical surface with a radius about 139.5 to 170.5 mm and a diameter about 160 mm, wherein the thickness of the third lens element is about 38.7 to 47.3 mm;
wherein the first lens element, the second lens element and the third lens element are positioned concentric along an optical axis;
wherein the first lens element is a concave-plano lens element, the second lens element is a concave-convex lens element and the third lens element is a convex-convex lens element;
wherein the first lens element, the second lens element and the third lens element are made of material(s) with refractive index about 1.755 to 2.145;
wherein the distance between the first lens element and the second lens element is about 45.45 to 55.55 mm and the distance between the second lens element and the third lens element is about 12.6 to 15.4 mm.

12. The terahertz-gigahertz fisheye lens system as claimed in claim 11, wherein the configuration of these lens elements is designed for the terahertz-gigahertz rays in the frequency range of 20 GHz to 200 GHz.

13. The terahertz-gigahertz fisheye lens system as claimed in claim 11, wherein at least one of the lens elements is made of quartz.

14. The terahertz-gigahertz fisheye lens system as claimed in claim 11, wherein an object positioned on the left side of the first lens element and inside the FOV range about 160° may be detected by an image sensor positioned on the right side of the third lens element.

15. The terahertz-gigahertz fisheye lens system as claimed in claim 11, wherein an image of an object positioned on the left hand side of the first lens element at a finite distance is detected by an image sensor positioned on the right hand side of the third lens element at a finite distance.

16. The terahertz-gigahertz fisheye lens system as claimed in claim 11, further comprising an image sensor positioned on the right side of the third lens elements, wherein the distance between the right surface of the third lens element and the image sensor is about 51 mm and the diameter of the image sensor is about 120 mm, wherein the image sensor and these lens elements are centered with respect to the optical axis.

17. The terahertz-gigahertz fisheye lens system as claimed in claim 16, wherein the size and spacing of these lens elements may be scaled with the size of the image sensor.

18. The terahertz-gigahertz fisheye lens system as claimed in claim 11, further comprises an aperture stop is positioned between the first lens element and the second lens element, wherein the distance between the right surface of the first lens element and the aperture stop is about 40.5 mm and the diameter of the aperture stop is about 150 mm, wherein the aperture stop and these lens elements are centered with respect to the optical axis.

19. The terahertz-gigahertz fisheye lens system as claimed in claim 18, further comprising an image sensor positioned on the right side of the third lens elements, wherein the distance between the right surface of the third lens element and the image sensor is about 51 mm and the diameter of the image sensor is about 120 mm, wherein the image sensor and these lens elements are positioned concentric along the optical axis.

20. The terahertz-gigahertz fisheye lens system as claimed in claim 19, wherein both the size of the aperture stop and the distance between the aperture stop and the first lens element may be scaled with the size of the image sensor.
